(19) United States
(12) Patent Application Publication
(10) Pub. No.: US 2012/0116921 A1
(43) Pub. Date: May 10, 2012

(54) METHOD AND COMPUTER SYSTEM FOR PURCHASE ON THE WEB

(75) Inventors: Alexis Fogel, Paris (FR); Guillaume Maron, Paris (FR); Jean Guillou, Paris (FR)

(73) Assignee: Kwift SAS, Puteaux (FR)

(21) Appl. No.: 13/113,987

(22) Filed: May 23, 2011

(30) Foreign Application Priority Data
Nov. 8, 2010 (FR) 10/04360
Nov. 8, 2010 (FR) 10/04361

(51) Int. Cl. G06Q 30/00

(52) U.S. Cl. 705/26.81

(57) ABSTRACT

A method for online purchase automation, comprising identifying when the user has selected to navigate to or receive a web page related to a purchasing action, identifying when content of the web page is received; analyzing the web page concurrent with the purchase action, without requiring detailed structural information about the web page in advance, and determining whether the web page is related to a purchasing action, by parsing the web page or related data elements. If the web page is related to a purchasing action, the next steps are determining the user interface elements of the web page or related data elements, retrieving site-independent customer data for the purchase based on the analyzing of the user interface elements, simulating user input using the site-independent customer data to populate at least portions of the web page, and displaying to the user the populated purchasing page for user action.

### CROSS-REFERENCE TO RELATED APPLICATIONS

This application is a Nonprovisional Patent Application claiming benefit under 35 USC §119(a) of the following applications, each naming Guillaume Maron, Jean Guillou, and Alexis Fogel:

French Patent Application No. 10/04360, filed Nov. 8, 2010, with the title “Méthode et système d′ exécution informatisée de tâches sur Internet”, and

French Patent Application No. 10/04361, filed on Nov. 8, 2010, with the title “Procédé et système informatisée d′achat sur le web”.

Each application cited above is hereby incorporated by reference for all purposes. The present disclosure also incorporates by reference, as is set forth in full in this document, for all purposes, the following commonly assigned applications/patents:

U.S. patent application Ser. No. ______ [Attorney Docket No. 93180-800065] filed of even date herewith and entitled “TASK AUTOMATION FOR UNFORMATTED TASKS DETERMINED BY USER INTERFACE PRESENTATION FORMATS” naming Fogel, et al. (hereinafter “Fogel II”);

U.S. patent application Ser. No. ______ [Attorney Docket No. 93180-800066] filed of even date herewith and entitled “ANTHROPOMIMETIC ANALYSIS ENGINE FOR ANALYZING ONLINE FORMS TO DETERMINE USER VIEW-BASED WEB PAGE SEMANTICS” naming Fogel, et al. (hereinafter “Fogel III”);

U.S. patent application Ser. No. ______ [Attorney Docket No. 93180-800067] filed of even date herewith and entitled “METHOD AND SYSTEM FOR EXTRACTION AND ACCUMULATION OF SHOPPING DATA” naming Guillaume, et al. (hereinafter “Guillaume I”).

### BACKGROUND OF THE INVENTION

This disclosure relates to the field of electronic commerce and more particularly to automated or assisted methods of purchasing on the Web, especially on merchant websites, and a system implementing the method.

One of the factors explaining the rise of the Web was an opportunity for companies to develop and create commercial websites on which consumers can make a purchase, offering a new way to shop remotely. One common online purchase model is one based on building a shopping cart in which items are virtually placed. Upon user expression of checkout or desire to consummate the purchase, a purchasing transaction is initiated. To complete a purchasing transaction, a user may need to provide consumers' personal data, including shipping address, billing address and other characteristics of payment methods. Finally, the transaction is completed after going through the purchasing pages and the user's confirmation of the purchase order.

Studies have shown that more than half of the acts of shopping on the Web are not completed, consumers abandoning the procedure due to the complexity of steps required to finalize the purchase act, which involves the supplying and therefore the seizure of numerous personal information (information for shipping and billing data for payment method, etc.). In addition, with each execution of a purchase act, such sensitive personal information is transmitted over the network and may be intercepted and decoded, by using for example spyware, which stores the user's keystrokes.

Solutions have been devised to make it easier for consumers to purchase products online. U.S. Pat. No. 5,960,411 describes a solution for purchasing automation. However, it requires the processing logic to be performed by the vendor's servers. It also requires a specific implementation for each merchant website, including a consumer personal information database for each consumer website. Moreover, this solution is not based on the shopping cart purchase model most commonly used on the Web.

Thus it is desirable to provide a solution that is compatible with the vast majority of merchant Web sites, using the shopping cart purchase model, facilitating the consumer buying process, including avoiding the seizure of consumers' personal information.

### BRIEF SUMMARY OF THE INVENTION

This disclosure provides systems and methods that make user interactions with online shopping websites easier, independent of the site they are visiting. The site-independent solution makes a user's Web shopping experience less burdensome across a host of merchant sites.

In one embodiment, methods and/or systems are provided that upon detection of a user's desire to consummate a shopping transaction (e.g., when the user clicks on the “checkout” button), offer an option for the user to choose either “assisted” or “automated” purchasing.

In one aspect, where the user selects an assisted shopping option, the users shopping pages will be pre-filled with known consumer information, that is site-independent, on the page visited by the user. In other cases, where fields could not be all pre-filled, the user will be provided a mechanism to select data (e.g., drop-down list) for a particular field or be allowed to enter data. After the data is filled either via the consumer database and/or via consumer solicitation thereof, the user can then take the macroscopic action of the form manually (e.g., by pressing the authenticate button, or next or submit button, etc.).

In another aspect, where the user opts to automate a transaction, shopping pages (e.g., billing information page, shipping information page, payment method page, etc.) are pre-filled with site-independent data and the macroscopic action (e.g., “authenticate”, “create account”, “submit”, “next”, etc.) on the page is automatically executed on behalf of the user. In one embodiment, the automated execution of a page's macroscopic action is taken until the user reaches the purchasing confirmation page. In one case, the purchasing automation would also validate the Terms and conditions of the purchase.

In one embodiment, the purchasing automation method comprises the following steps: a) a user's selection and placing of articles, of interest to a consumer, in a shopping cart, b) obtaining confirmation from the user that they intended to purchase what is in the shopping cart by the consumer; c) obtaining confirmation from the user that they intend to complete the purchase process using a purchasing automation system (e.g., by providing a pop-up to the user from which the user may select either “assist” or “automate” radio button option), d) the execution of the purchase order by the purchasing automation system, wherein the purchasing automation system preferably performs, on each page of the shopping sequence, the following steps: d1) analysis of components (including images) of the web page and identifying the elements of user interaction; d2) determining, based on the elements of user interaction, possible anthropomimetic actions (i.e., macroscopic actions that a user can take on the web page from the user's point of view rather than from the point of view of the encoding of the web page), d3) performing, in a macroscopic sense, the anthropomimetic action determined in step d2, providing the required personal information of the consumer obtained from a database of personal consumer information and/or from solicitation from the consumer, until one of these actions generate the loading of a new web page or lead to a significantly changing the page being analyzed (e.g., AJAX requests, or dynamic JSP) of the website on which the purchase is underway, and repeating steps d1) to d3) until a payment validation or confirmation page for the purchase is reached.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 is a simplified block diagram of one embodiment of a networked, Internet client server system.

FIG. 2 is a simplified block diagram of one embodiment of an Internet client machine, running components of the system described herein.

FIG. 3 shows the conventional sequence of steps of the action taken by a consumer during a purchase on a website using the shopping cart model.

FIG. 4 is one embodiment of the sequence of steps to be performed by a consumer using online purchase automation as described herein.

FIG. 5 is an illustration of an Internet assistant and its components.

FIG. 6 is one embodiment of the steps in online purchase automation.

FIG. 7 is a flow chart illustrating the process of analyzing a web page according to the present invention.

FIGS. 8-15 illustrate various views of one embodiment of an Internet assistant, an application for user interactions with purchasing automation.

### DETAILED DESCRIPTION OF THE INVENTION

As explained herein, methods, systems and apparatus are provided that automate online shopping pages in a site-independent fashion; the automation works across a host of merchant websites and precludes the need for such programming logic to be implemented by each website. While the web pages might be provided over one or more different types of networks, such as the Internet, and might be used in many different scenarios, many of the examples herein will be explained with reference to a specific use, that of a user interacting with web pages from an e-commerce web site, with user interactions including purchase selection, provision of purchase and/or user information (e.g., name, address, credit card number), confirmation of purchase details (e.g., totals, shipping, etc.) as well as storing such pages and associated transactional information, and doing so in an automated manner where appropriate.

Those skilled in the art will appreciate that logic used to automate shopping pages have many applications and that improvements inspired by one application have broad utility in diverse applications that employ techniques used to automate shopping pages.

Below, example hardware is described that might be used to implement aspects of the present invention, followed by a description of software elements.

### Network Client Server Overview

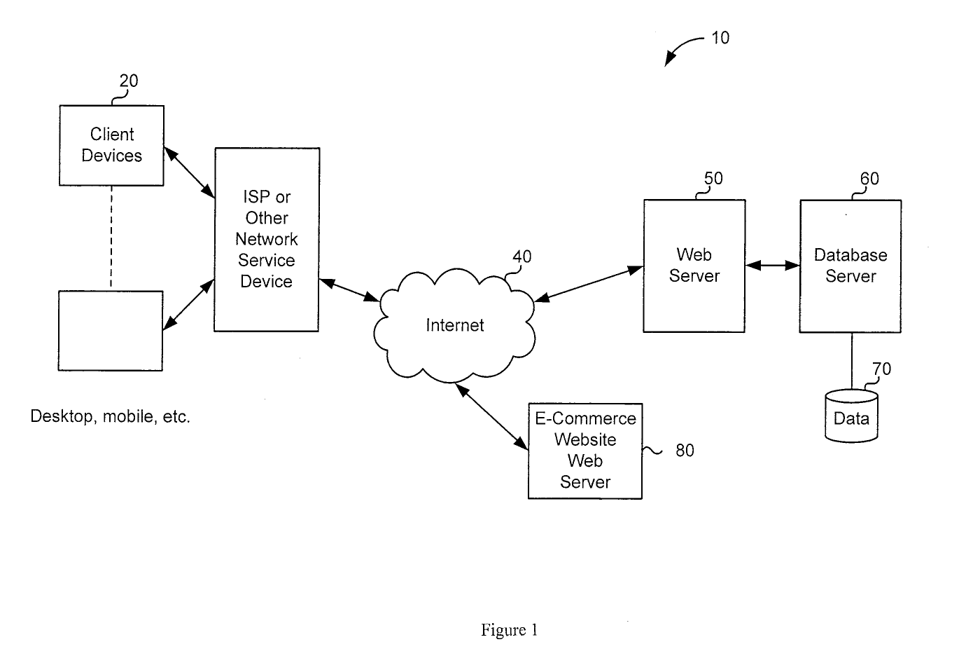

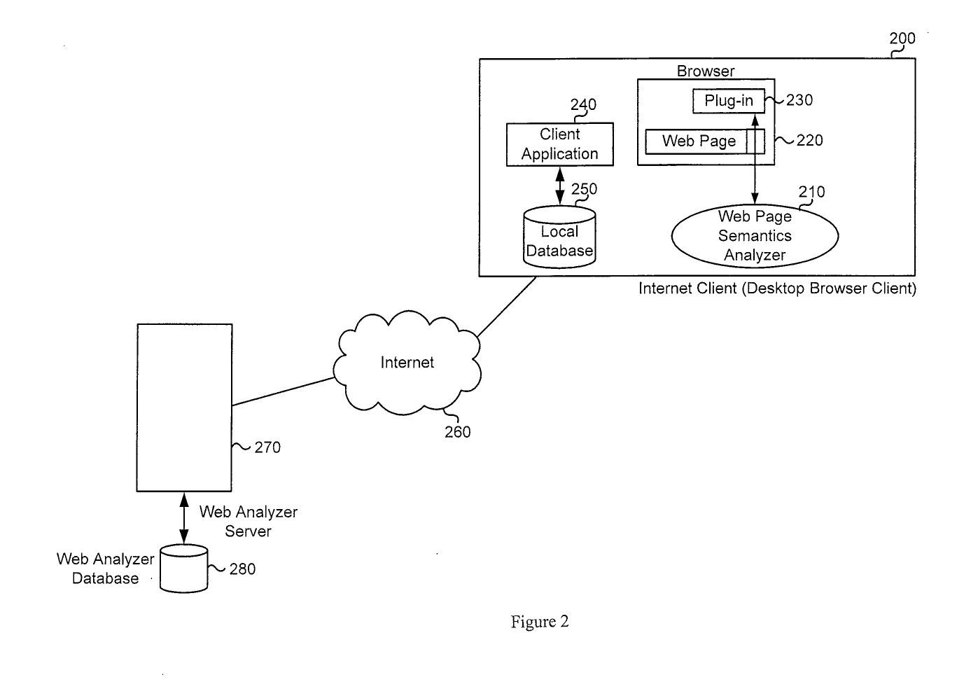

FIG. 1 is a simplified functional block diagram of an embodiment of an interaction system 10 in which embodiments of the purchasing automation system described herein may be implemented. Interaction system 10 is shown and described in the context of web-based applications configured on client and server apparatus coupled to a network (in this example, the Internet 40). However, the system described here is used only as an example of one such system into which embodiments disclosed herein may be implemented. The various purchasing automation system components described herein can also be implemented in other systems.

Interaction system 10 may include one or more clients 20. For example, a desktop web browser client 20 may be coupled to Internet 40 via a network gateway. In one embodiment, the network gateway can be provided by Internet service provider (ISP) hardware 80 coupled to Internet 40. In one embodiment, the network protocol used by clients is a TCP/IP based protocol, such as HTTP. These clients can then communicate with web servers and other destination devices coupled to Internet 40.

An e-commerce web server 80, hosting an e-commerce website, can also be coupled to Internet 40. E-commerce web server 80 is often connected to the Internet via an ISP. Client 20 can communicate with e-commerce web server 80 via its connectivity to Internet 40. E-commerce web server 80 can be one or more computer servers, load-balanced to provide scalability and fail-over capabilities to clients accessing it.

A web server 50 can also be coupled to Internet 40. Web server 50 is often connected to the Internet via an ISP. Client 20 can communicate with web server 50 via its connectivity to Internet 40. Web server 50 can be configured to provide a network interface to program logic and information accessible via a database server 60. Web server 50 can be one or more computer servers, load-balanced to provide scalability and fail-over capabilities to clients accessing it.

In one embodiment, web server 50 houses parts of the program logic that implements the purchasing automation system described herein. For example, it might allow for downloading of software components, e.g., client-side plug-ins and other applications required for the systems described herein, and synching data between the clients running such a system and associated server components.

Web server 50 in turn can communicate with database server 60 that can be configured to access data 70. Database server 60 and data 70 can also comprise a set of servers, load-balanced to meet scalability and fail-over requirements of systems they provide data to. They may reside on web server 50 or on physically separate servers. Database server 60 can be configured to facilitate the retrieval of data 70. For example, database server 60 can retrieve data for the purchasing automation system described herein and forward it to clients communicating with web server 50. Alternatively, it may retrieve transactional data for the associated merchant websites hosted by web server 50 and forward those transactions to the requesting clients.

One of the clients 20 can include a desktop personal computer, workstation, laptop, personal digital assistant (PDA), cell phone, or any WAP-enabled device or any other computing device capable of interfacing directly or indirectly to Internet 40. Web client 20 might typically run a network interface application, which can be, for example, a browsing program such as Microsoft's Internet Explorer™, Netscape Navigator™ browser, Google Chrome™ browser, Mozilla's Firefox™ browser, Opera's browser, or a WAP-enabled browser executing on a cell phone, PDA, other wireless device, or the like. The network interface application can allow a user of web client 20 to access, process and view information and documents available to it from servers in the system, such as web server 50.

Web client 20 also typically includes one or more user interface devices, such as a keyboard, a mouse, touch screen, pen or the like, for interacting with a graphical user interface (GUI) provided by the browser on a display (e.g., monitor screen, LCD display, etc.), in conjunction with pages, forms and other information provided by servers. Although the system is described in conjunction with the Internet, it should be understood that other networks can be used instead of or in addition to the Internet, such as an intranet, an extranet, a virtual private network (VPN), a non-TCP/IP based network, any LAN or WAN or the like.

According to one embodiment, web client 20 and all of its components are operator configurable using an application including computer code run using a central processing unit such as an Intel Pentium™ processor, an AMD Athlon™ processor, or the like or multiple processors. Computer code for operating and configuring client system 20 to communicate, process and display data and media content as described herein is preferably downloaded and stored on a processor readable storage medium, such as a hard disk, but the entire program code, or portions thereof, may also be stored in any other volatile or non-volatile memory medium or device as is well known, such as a ROM or RAM, or provided on any media capable of storing program code, such as a compact disk (CD) medium, a digital versatile disk (DVD) medium, a floppy disk, and the like. Additionally, the entire program code, or portions thereof, may be transmitted and downloaded from a software source, e.g., from one of the servers over the Internet, or transmitted over any other network connection (e.g., extranet, VPN, LAN, or other conventional networks) using any communication medium and protocols (e.g., TCP/IP, HTTP, HTTPS, FTP, Ethernet, or other media and protocols).

It should be appreciated that computer code for implementing aspects of the present disclosure can be C, C++, HTML, XML, Java, JavaScript, etc. code, or any other suitable scripting language (e.g., VBScript), or any other suitable programming language that can be executed on a client or server or compiled to execute on a client or server.

### Purchasing Automation Overview

In certain embodiments, methods and systems are provided that make it easier and more secure for a user to shop online. For example, fields in the sequence of shopping pages can be pre-filled, thereby avoiding the need for a user to re-enter the same personal information for every shopping transaction, either on the same or a different shopping website. The fields can be pre-filled from a personal consumer information database. Such pre-filling from a database also helps increase security of online transactions, since the same information would not have to be typed in over and over by the user, thereby thwarting efforts of software keyloggers to gain access to sensitive user information. As another example the shopping pages can be auto-executed on behalf of a user.

In certain aspects, techniques to determine webpage semantics, independent of any particular website, are used for online purchase assistance and automation. The semantics analysis of a webpage can provide understanding of elements of a webpage, the form types of a webpage, and possible macro-actions on the pages from an anthropomimetic perspective, i.e., considering the content, forms and interaction elements as would be perceived and dealt with by a human user, as opposed to by merely considering the web pages in their native form, such as HTML formatted files. Details of webpage semantics analysis are provided in Fogel III.

The webpage semantics analysis system can be particularly useful in automation of online shopping, where the user has to provide a slew of information (e.g., account/registration, billing information, shipping information, for each website on various pages before completing a shopping transaction. In one embodiment, online shopping is automated by understanding the meaning of elements, forms and macro-actions of a user-navigated webpage. For example, once it is determined that a user is on a shopping cart page, information can be extracted from elements (e.g., item, quantity, and price) of the page and stored, along with the associated context information, for subsequent use (i.e., a confirmation page or history page). As another example, once the semantic structure of a webpage leads to the understanding that it is a shipping information page, the name and address elements of that page can be pre-filled (e.g., from a personal consumer database) and the macroscopic action (e.g., submit or next page) can be taken on behalf of the user.

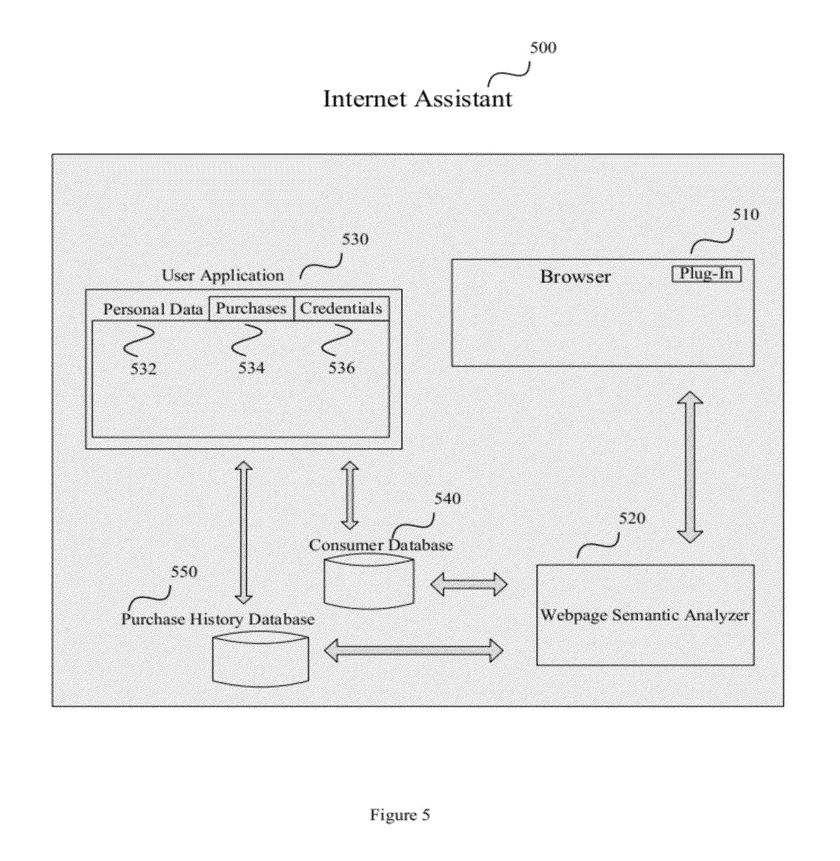

Webpage analysis and semantic understanding can also help in developing and maintaining a consumer personal information database. Such a system may contain information such as accounts or credentials associated with merchant websites, payment information, shipping information, preferences information, etc. With the understanding of elements of a page, user-supplied information can be extracted and stored in a database, along with the contextual understanding of the extracted data's element (e.g., first name =“John”, last name =“Doe”, Shipping Address=“100 Main St.”, etc.). Personal information can also be entered by the user manually. In one embodiment, an application interface (as described below for FIG. 5, component 530) is provided to the user to enter information to store in the consumer database. Such information can then be used to pre-fill fields of a subsequent shopping transaction. The subsequent transaction does not need to be for the same merchant, as at least in one embodiment the data is stored with its contextual understanding and independent of website constraints, thus making the solution available to a host of merchant sites.

In other aspects, online shopping is made easier by capturing transactional details for future review by the user in a purchasing history database. For example, user actions taken on a page can be recorded. As explained above, shopping cart details can also be extracted and stored along with contextual information (e.g., product identifier, name, quantity, and price) based on the semantic understanding of elements of a page. Advantageously, screenshots of pages of a shopping transaction can be captured and stored. The history database can then be used by a customer to answer questions such as “what was purchased”, “when was something purchased”, “how much was paid”, “has the item been received”, etc. in a consolidated view for all transactions on the myriads of websites that a consumer made purchases from. Such an integrated purchasing transaction database can greatly ease a user's task in managing all purchasing transaction from a host of merchant sites (i.e. the user does not have to go to each individual merchant website, from where she purchased items, in order to get answers to the above type of questions pertaining to a shopping transaction). More details about the shopping data extraction and maintenance of a purchasing history database are provided in companion application, Guillaume I.

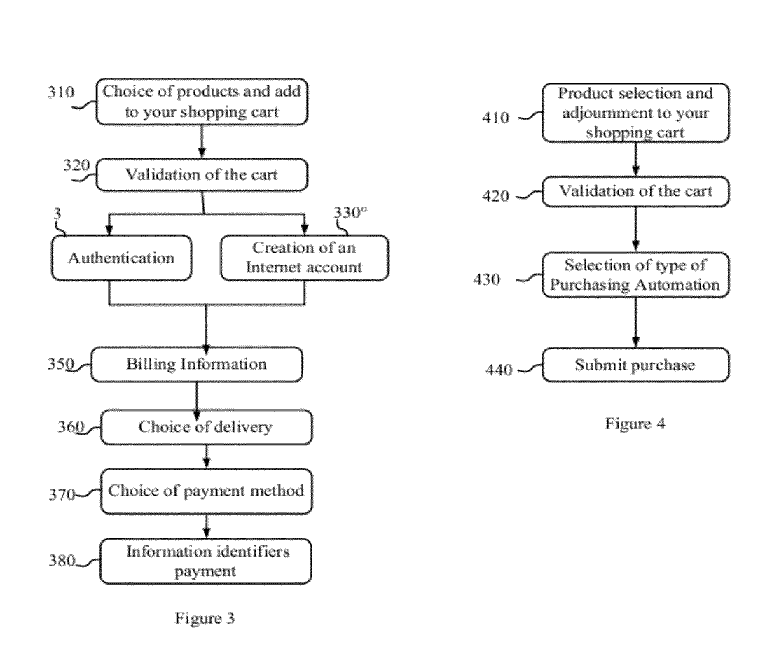

FIG. 3 shows a conventional sequence of steps of actions taken by a consumer during a purchase on a merchant site, using the shopping cart model. At step 310, a user selects products to add to a shopping cart. At step 320 a shopping cart validation/purchasing process is initiated. Then at step 330, an account may be created where the user does not have an existing shopping account with the merchant website. In other cases, an account may not need to be created because the user can checkout using a “guest” account. Where a registration form is recognized during the purchasing automation, the user may provide a password for the account or may ask the application software to generate a strong password on her behalf. A user will then go on to provide billing information at step 350, choice of delivery method at step 360, and choice of payment method and credit card information at step 370. Finally, the user will reach the confirmation page to review and either confirm or cancel the transaction at step 380.

FIG. 4 illustrates steps taken in one embodiment of online automation as described in the disclosure herein. A user may still add products to a shopping cart at step 410 and initiate a purchasing/validation process at step 420. The user may also be required to enter a choice of purchasing option at step 430, e.g., selecting the type of automation desired, such as “automated” or “assisted” purchasing. However, various other steps such as providing billing information, delivery method and payment information will be automated for the user, where so chosen. After the user's automated steps are executed, the user will be provided with a submit or confirmation page to either confirm or cancel the transaction at step 440. As illustrated in FIGS. 3 and 4, the number of steps required for a user to transact can be greatly reduced by automating various sequences of pages of a typical online purchasing transaction. The advantage of automation becomes even more obvious when one takes into account the slew of information that a user provides, repeatedly, as input fields on those pages. Furthermore, where a user device is a mobile device or another device without a keyboard, the advantages of automation are further realized.

In certain aspects, shopping assistance can be provided by wholly or partially automating the purchasing pages. For example, known user data can be used to automatically populate fields of a shopping page. Where more than one possible value exists for an element on the page, a selection mechanism (e.g., a drop-down list) can be provided for choosing from the possible values for the field to assist the user. Where no data is available, the information can be solicited from the user directly. Furthermore, actions often repeated in an online shopping sequence of pages can be taken automatically on behalf of the user (e.g., automatically create or select a user account with associated consumer information, provide shipping details and submit page, provide billing information and submit page, etc.) where a user has provided a preference for automation of that task. These tasks can be achieved in a site-independent fashion by having an understanding of elements, forms, and actions of a webpage.

In one embodiment, upon ascertaining a user's desire to consummate a purchase, a pop-up presenting the option to either assist or automate the user's purchasing transaction can be provided. For example, when a user hovers over a “checkout” element, four arrows surrounding the checkout button can be rendered (i.e., indicating that shopping assistance is available). In one instance, the four arrows are displayed to the user by detecting that the user is on a page containing a shopping cart element, by using the Guillaume I cart analysis. Upon pressing of the “checkout” button, a user interface (as described below for FIG. 5, component 530—user application) page is brought up with radio buttons for type of purchasing assistance options (e.g., assist or automate the user's purchasing transaction). In one embodiment, the pop-up software where a user selects purchasing type, also allows the user to provide further information about for purchasing automation. For example, the user may provide which address to use for shipping, which address to use for billing, which credit card to use for payment, etc.

In one aspect, where a user has selected the assist purchase option, user-supplied data can be retrieved from a consumer database. The consumer database may reside locally, remotely, or partially locally and remotely. The retrieved data can then be used to populate the shopping page fields, thereby allowing the user to verify that information visually and then manually continuing to the next page of the shopping sequence (e.g., by pressing the submit button on the bottom of the page). In certain aspects, the user may also be prompted to provide or select some information required by the shopping pages. This may be required where there is no user supplied information for a particular element, or when more than one possible value exists for a field, or when the meaning of a particular element was not decipherable by the semantics analysis of the page, as may be required for pre-populating. In one aspect, where the user has more than one option for a possible field, the user is provided with a selection element, e.g., a drop-down list to choose a value for the field, at the beginning of the checkout process, where the user was presented with Internet assistant application to choose purchasing automation type. Such selection information can be for example, shipping or billing address, or payment type to use for the purchase.

In another aspect, where a user has selected automate purchase option, user-supplied data can be retrieved from a consumer database and used to populate the shopping page fields. In some instances, the user may be prompted to provide any missing data or select from multiple possible data values. The automated option then may lead to the macro-action on a page to be executed on behalf of the user (e.g., filling in shipping information and executing the “next page” action, filling in billing information and executing the “submit” page action, etc.). In one case, the shopping pages in a shopping transaction sequence will be filled and auto-executed until the purchase confirmation page is reached. In one aspect, this automation is performed based upon a user's preference for automation.

FIG. 5 is an illustration of components of an Internet assistant that can help automate online purchasing transactions. Internet assistant 500 may in one embodiment be installed on one of the client devices 200 of FIG. 1. It includes a browser plug-in 510, webpage semantics analyzer 520, user application 530, consumer database 540, and purchase history database 550. Plug-in 510 takes user-navigated pages and passes them to the webpage analyzer 520 for semantic understanding, data extraction, and pre-filling of data. The features of these two components and how they operate are explained in more details in Fogel III.

User application 530 is used for both supplying and viewing of personal and transaction history information. User application 530 interacts with consumer database 540 and purchase history database 550. Consumer database 540 may contain information such as identity of a user, shipping address, billing address, email, payment information, credit card information, credential information for merchant sites (e.g., login and passwords for websites), etc. Database 540 may be populated by webpage analyzer system 520, by extracting user supplied information, along with the associated meaning of an element and storing it in consumer database 540. Alternatively, database 540 may be populated via the user application interface 530. Purchase history database 550 may be populated by webpage semantics analyzer, by extracting transactional details, screenshots of pages, etc. and populating the history database. Guillaume I further explains methods and systems for purchasing history database. Additionally, a user may manually enter purchasing history information. Preferably, databases 540 and 550 are encrypted using methods available to those skilled in the art. Databases 540 and 550 may reside locally, remotely or both.

User application 530 can be used to view/provide/modify personal information such as credentials/accounts, addresses, email, etc. Tabs 532, 534, and 536 are used for managing various user information and views. Tab 532 allows for viewing and modification of basic user data such as name, addresses, emails, phone numbers, etc. Various options on this tab also allow the user to manage payment types (e.g., different credit cards, different payment systems, such as PayPal™ and the like, or whatever the vendor accepts as electronic payment.). Tab 534 allows for the user to view purchase history details of transactions, including associated screen shots of pages executed during a transaction. Tab 536 has information of credentials and accounts for various merchant websites. It also allows a user to view the strong password created by assistant 500 and to hide it. In another embodiment, credentials functionality allows for the user to select an option that creates a strong password on behalf of the user.

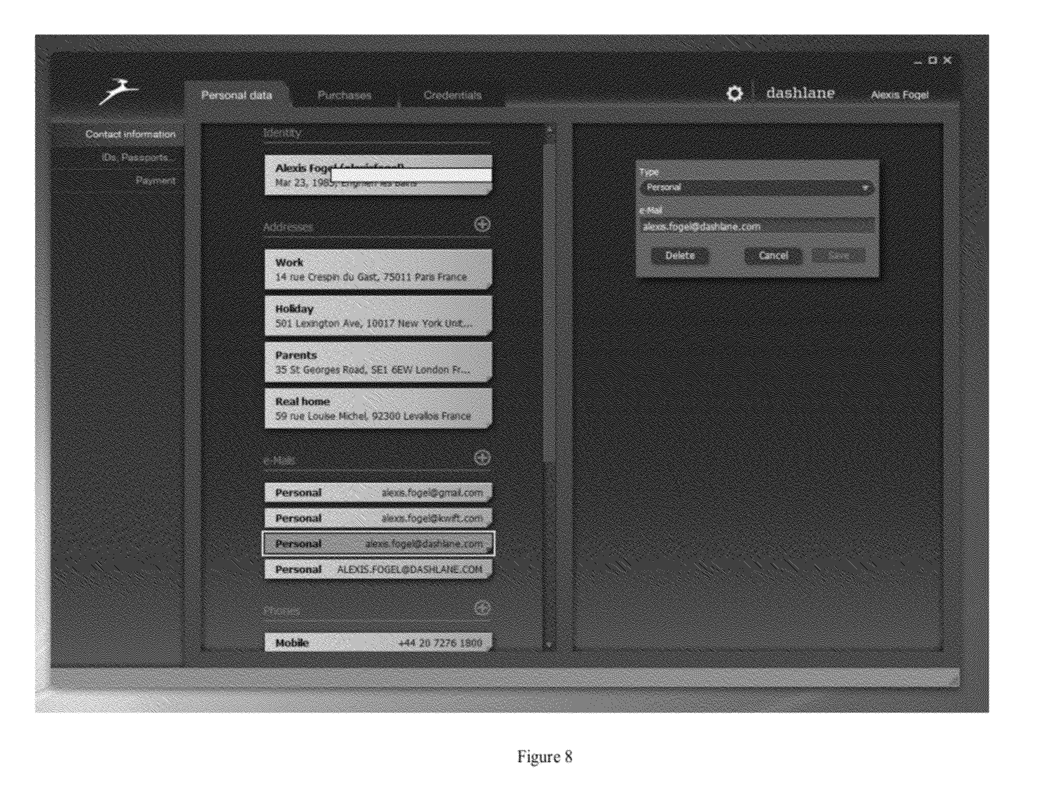

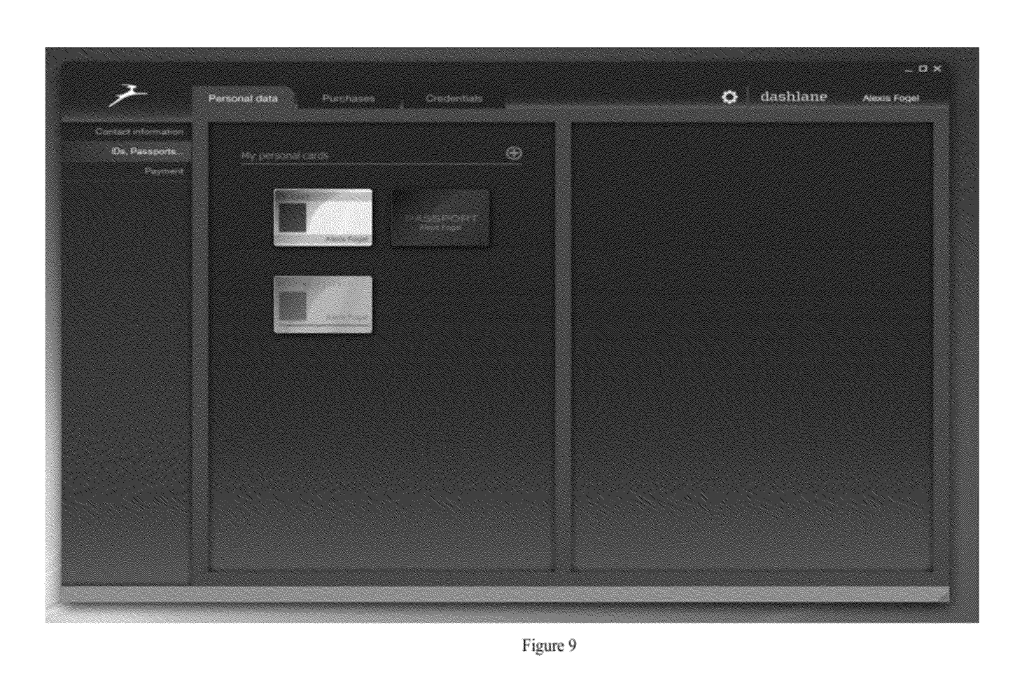

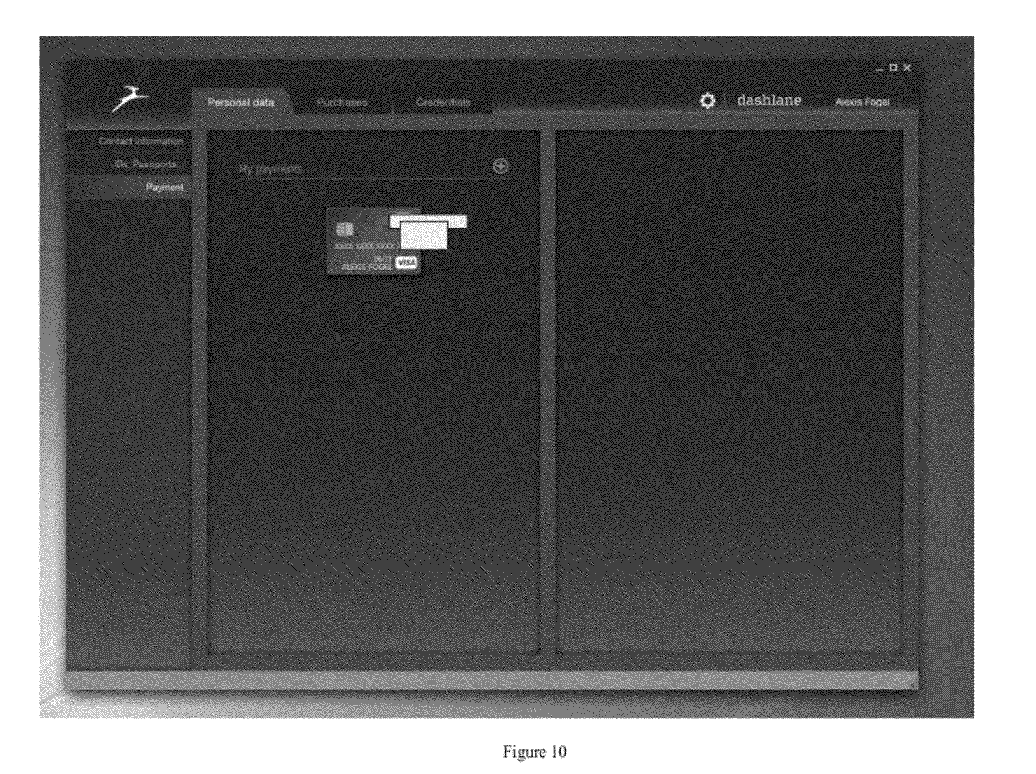

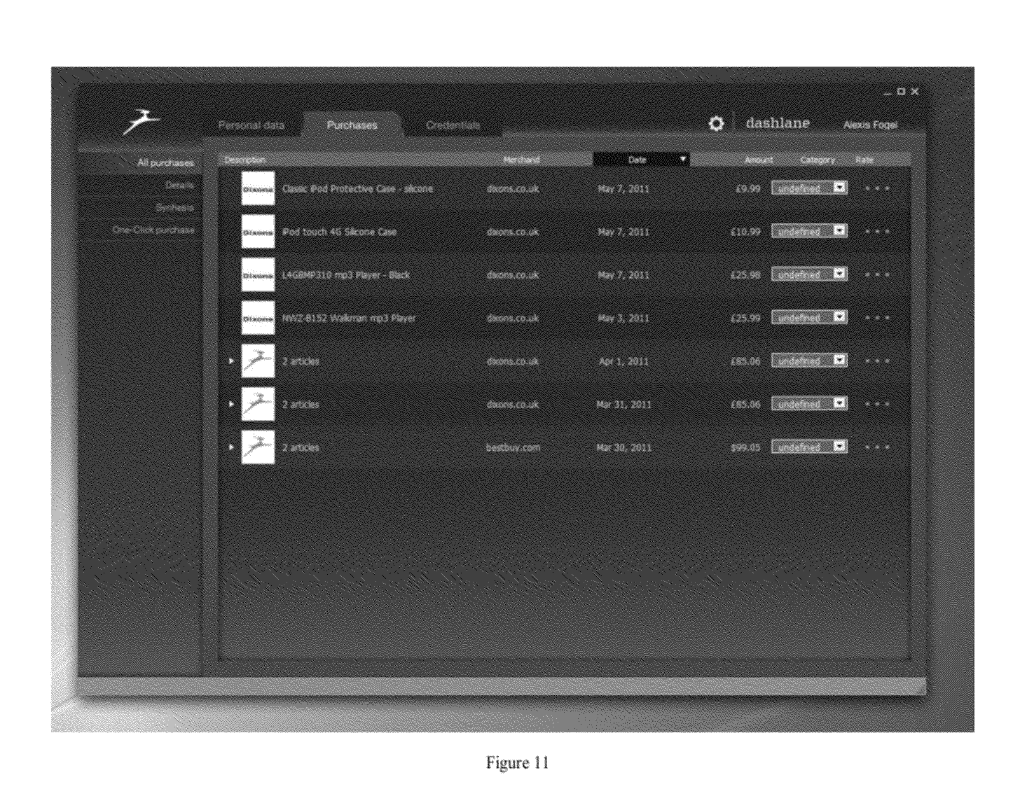

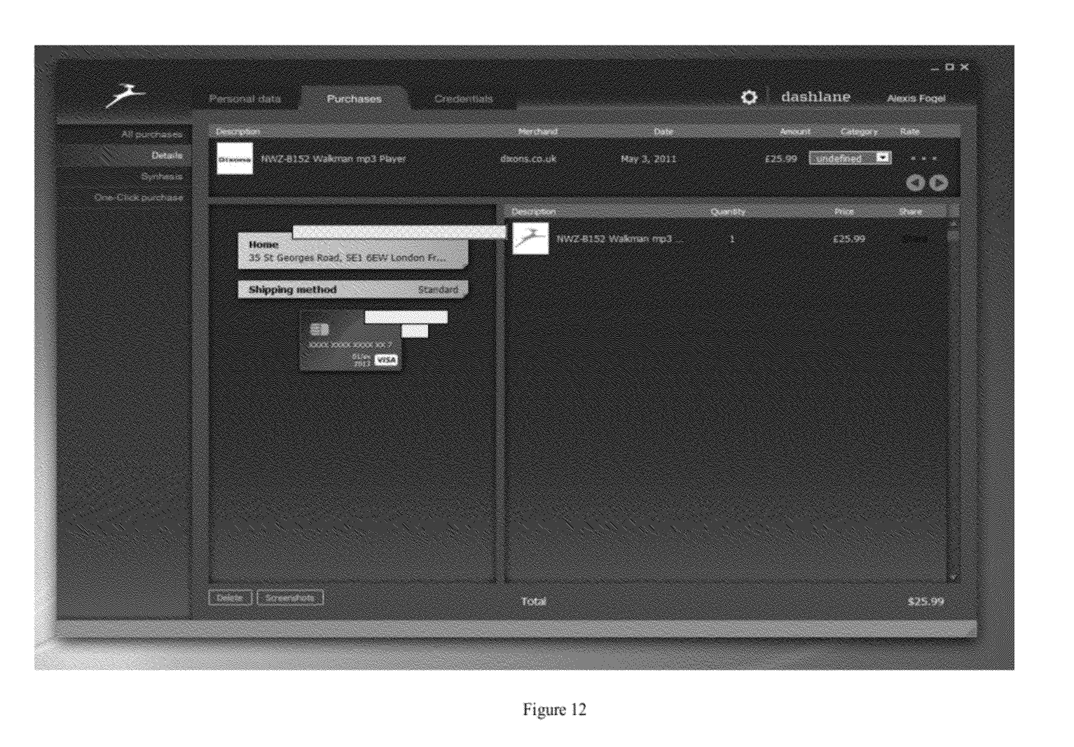

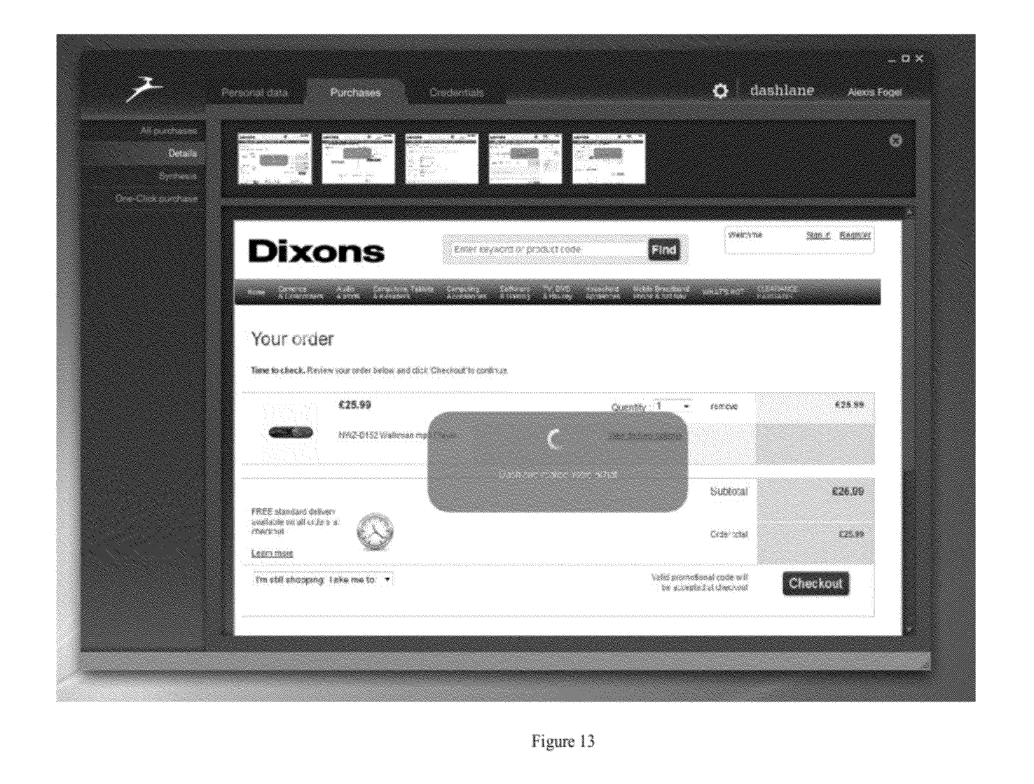

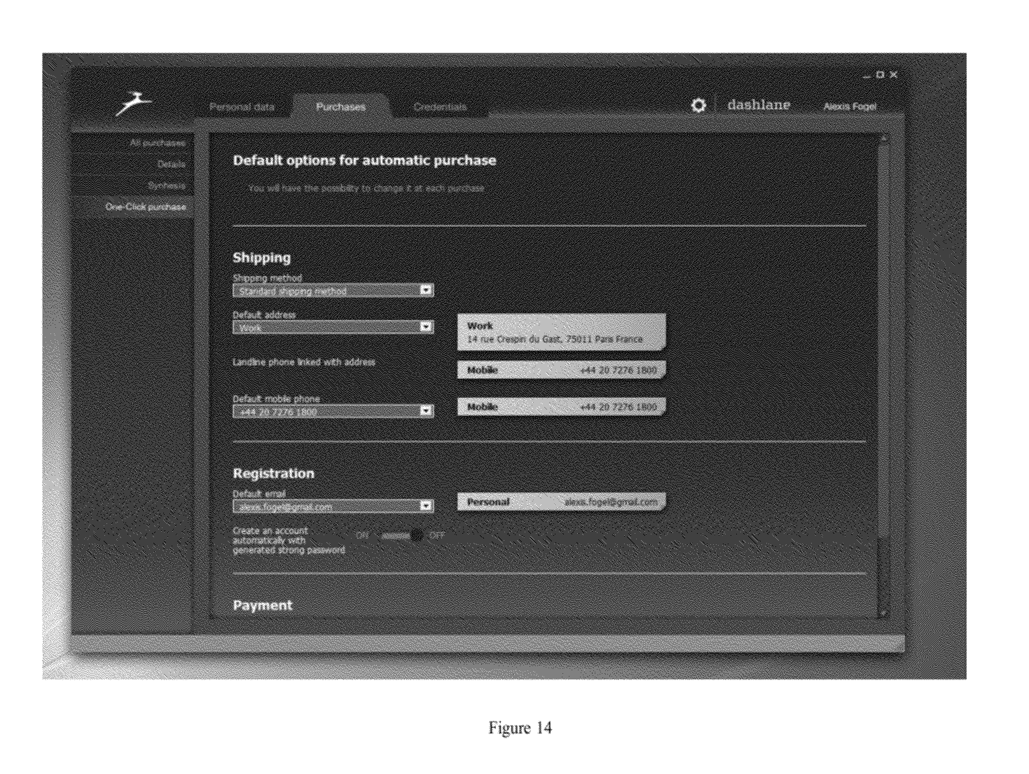

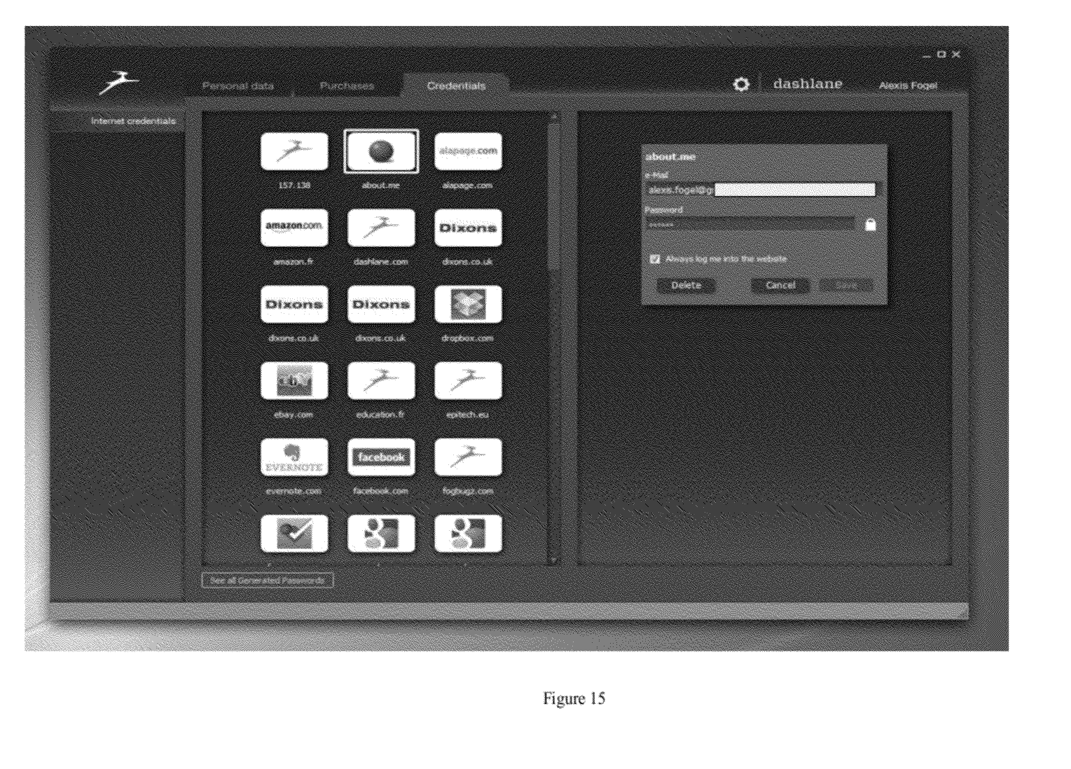

FIGS. 8-15 are screenshots of one embodiment of graphical user interface (GUI) components of an Internet assistant application as described in FIG. 5. FIG. 8 is a GUI for viewing and entering contact and other user personal information such as name, addresses, emails and phone numbers. FIG. 9 is a GUI for viewing and modifying user identification information such as driver license and passports. FIG. 10 is a GUI for viewing and modifying user payment information such as credit cards. FIG. 11 is a GUI tab that shows users past purchases. FIG. 12 is a drill-down view of one item from FIG. 11, providing further information about that purchase. It allows for the user to delete the purchase or to view screenshots of the purchasing sequence of navigated web pages. FIG. 13 shows one screenshot of a confirmation page of a purchase. FIG. 14 is a GUI where the user can view and modify default purchasing options. For example, the user can provide default shipping address, payment method, or account creation preferences (e.g., auto-generate a strong password). FIG. 15 shows user credentials or various accounts with various merchant websites.

In some embodiments, the personal information is extracted from pages. For example, a user might use a website once conventionally to make a purchase and have that process monitored, but not automated, so that the purchase automation system can gather preferred name, address, card #, etc. from the user's input.

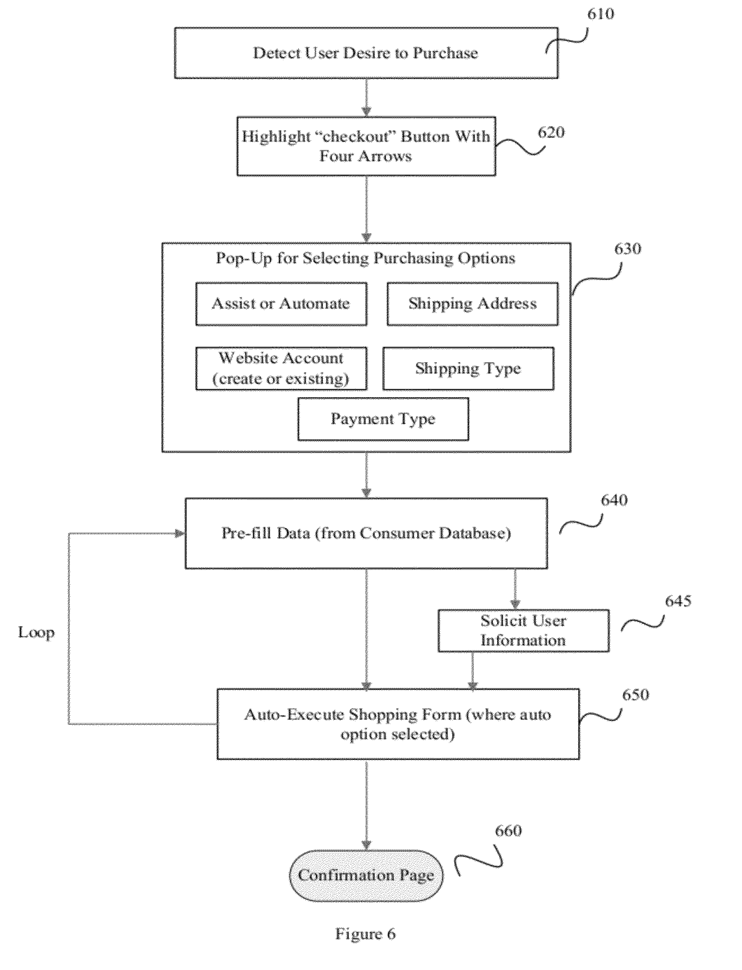

FIG. 6 is one embodiment of steps of online purchase automation. In step 610, the user desire to consummate a purchasing transaction is detected (e.g., when user mouses over the “checkout” button). This is possible because the purchase automation system has already, at this point, analyzed the page from a user perspective and knows what page elements correspond to what actions. For example, it might be simple and be a button that says “Press here to complete your purchase” but it might be a button that says “Confirm” and that would be interpreted by the user as the button to press (possibly because there is text elsewhere on the page that says “By pressing ‘Confirm’, you agree to pay for these items.”) to consummate the purchase.

In step 620, the online purchase automation signals to the user that it has detected a potential consummation and offers to take over part of the process. For example, in one implementation, the online purchase automation system might display four arrows in contrasting color surrounding a “checkout” button, indicating that automation assistance is available for the user. After the user presses the “checkout” button, she gets a pop-up at step 630 to provide purchasing options to the automation system. The Pop-up of step 630 allows the user to provide options such as automation type (assist or automate), website account to use for the purchase (or create one on behalf of the user for example where no account exists), shipping address, shipping type, and payment means (e.g., select a credit card to pay with).

In one embodiment, after the user selects the various shopping options, she may then start the transaction or cancel it. If the user selects start, then in step 640 fields of the various pages of a shopping sequence will be pre-filled from a consumer database as described in FIG. 5, component 540. Alternatively, where a field could not be pre-populated the user will be solicited to provide the missing information in step 645. Where the user has selected the “auto” execute option, step 650 will take the macro-action of the shopping form on behalf of the user (e.g., submit or next page). As indicated by the loop, steps 640-650 may be repeated until a confirmation page of the shopping sequence is reached. In one embodiment, a progress bar will show up during the execution of the sequence of steps described herein.

In one embodiment, when the confirmation page of the shopping tunnel is reached as in step 660, a summary page is rendered that summarizes all information, item-by-item, for the user to review prior to confirming or cancelling the purchase. In one embodiment, subsequently the macro-action for confirm purchase on the underlying webpage is executed on behalf of the user. The entire automated purchasing may take 20 seconds or less to complete, where the Internet connection is fast enough and little user input was required.

In one embodiment of a typical shopping tunnel (i.e., the sequence of pages that a user walks through to complete a shopping cart transaction) as described above, the following sequence of pages are automated: create account page (or select existing account), billing information page, shipping information page, shipping type page, payment information page, and finally the confirmation page.

In one embodiment, the purchasing automation method comprises the following steps: a) a user's selection and placing of articles, of interest to a consumer, in a shopping cart, b) obtaining confirmation from the user that they intended to purchase what is in the shopping cart by the consumer; c) obtaining confirmation from the user that they intend to complete the purchase process using a purchasing automation system (e.g., by providing a pop-up to the user in which the user may select either “assist” or “automate” radio button option), d) the execution of the purchase order by the purchasing automation system, wherein the purchasing automation system preferably performs, on each page of the shopping sequence, the following steps: d1) analysis of components (including images) of the web page and identifying the elements of user interaction; d2) determining, based on the elements of user interaction, possible anthropomimetic actions (i.e., macroscopic actions that a user can take on the web page from the user's point of view rather than from the point of view of the encoding of the web page), d3) performing, in a macroscopic sense, the anthropomimetic action determined in step d2, providing the required personal information of the consumer obtained from a database of personal consumer information and/or from solicitation from the consumer, until one of these actions generate the loading of a new web page or significantly changes the webpage being analyzed of the website on which the purchase is underway, and repeating steps d1) to d3) until a payment validation or confirmation page for the purchase is reached. In one embodiment, where step d3 does not lead to the loading of a new page and instead causes some significant changes to the page, the automation will lead to a new analysis of the significantly changed page (e.g., AJAX requests, or dynamic JSP for example); the analysis system essentially treats the changed page as a new purchasing page for analysis.

As used above, “anthropomimetic actions” means viewing the elements of a webpage in a way that corresponds to the logical behavior of a human being. For example, in this context a user interaction element means a programming element of a web page with which a user can interact (e.g., an HTML link, a button, form field). In addition, a macroscopic action achievable by a user is a global task (e.g., connect to a shopping account, provide billing information, or pay for the purchasing transaction, etc.) that requires a series of elementary actions (e.g., fill in a field, click a button, etc.) correlated with the identified elements of interactions.

In some aspects of the shopping pages automation, advantageously it further comprises a step of recording the actions carried out macroscopic. This recording is preferably based on screenshots. The consumer may at any time track the actions performed by the computer means for the validation of the purchase order, which has the advantage of guaranteeing to consumers that the computer resources used effectively carry out the order for purchases and to reassure themselves vis-à-vis the automatic nature of the process the invention.

In some aspects, components of a purchasing automation software system include: a first analysis module which determines the elements of user interaction within a webpage, a second module for determining the macroscopic actions that a user can take on a page by employing anthropomimetic means and by analyzing the user interaction elements found from module one, and a third control module for navigation which performs an anthropomimetic logic by executing a macroscopic action determined by the second determination module, and by providing the required personal information obtained either from a personal consumer information database and/or by soliciting such information from the consumer, until one of the macroscopic actions generates the loading of a new Web page. Some embodiment of methods and systems for implementing the first module for determining elements of user interaction within a page and the second module for determining macroscopic actions are further described in Fogel III.

The first analysis module is programmed to determine whether an element of a webpage is an element of user interaction and what is its nature based on the properties of elements as they have been established and described by those skilled in the art and/or using elements surrounding the element that allow a human user to understand its meaning. Such information as position on the page (in context) and associated text may be used to decipher meaning In one embodiment, the first module includes a feature that recognizes images present on a Web page in determining the element's nature. In one aspect, the recognition is made possible based on analysis of html attributes of the image and/or analysis of the text of the tooltip linked to that image and/or put into context, i.e., by putting the image in context (e.g., image reproducing the logo of a credit card) and/or by comparison with a database of images.

The second module for determining the macroscopic actions and logic anthropomimetic for the third module of navigation control uses a set of predetermined rules, including preferably a feature of self-learning to determine the possible macroscopic actions. Advantageously, the second module includes a feature to update the code of the first, second and third modules, in conjunction with a central database hosted on a remote computer server. The evolution of this central database is generated by the information provided by the auto-learning feature.

In addition, the computer program of the procurement system of the invention preferably comprises a fourth module for traceability, which ensures the recording screen shots of the various actions undertaken by the macroscopic third module of traffic control in the second database of purchase history.

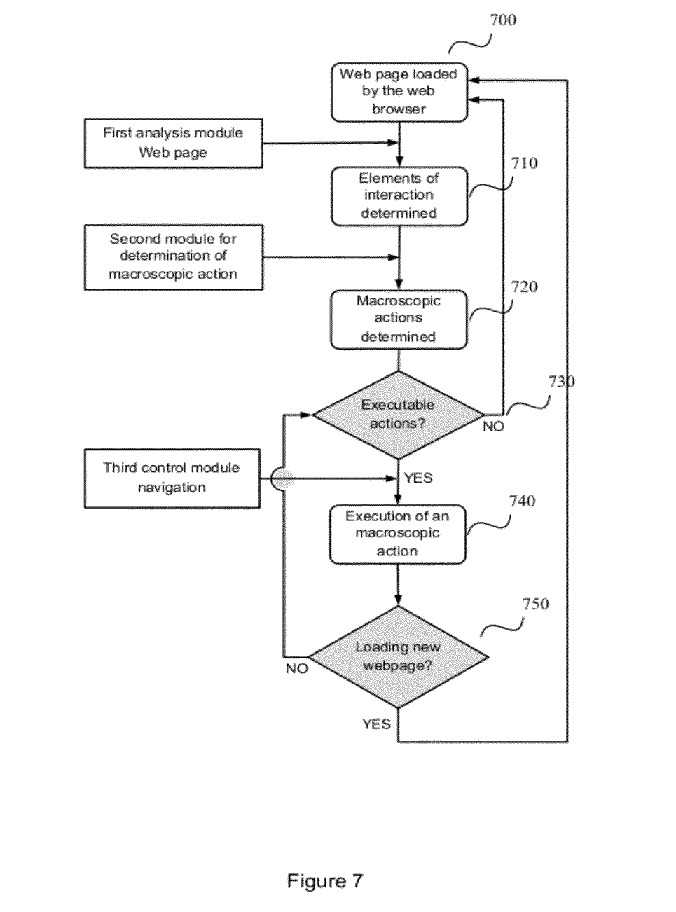

The sequence of steps for a user-navigated webpage, utilizing the first, second and third modules of computer program, is illustrated in FIG. 7. At step 700 a webpage is loaded by a browser. Then in step 710, the first analysis module is used to determine user interaction elements on the loaded webpage. After which, the second module determines the macroscopic actions that can be performed on the page at step 720. Step 730 determines if the action needs to be executed (e.g., where a user does not have an account with a purchasing site, and the navigation control is on the authenticate user form in the purchasing process, then no action would be required for this step because the user may be checking out as a “guest”). If no, then the flow is directed back to step 700 for web page loading. If yes, then at step 740, using the third control module of navigation, the macroscopic action is performed. Finally at step 750, there is a check to see if the performing of the macroscopic action at step 740 leads to the loading of a new webpage. If yes, then all the above steps will be repeated otherwise the flow will go to step 730 to determine if there is another executable action to take on behalf of the user.

The below example describes in detail the management of a Web page, using the steps describe above for FIG. 7, during the purchasing process. The example below uses a page where a consumer has the option to either create a customer account or to identify that the consumer already has such an account.

Step 1: After a webpage is loaded by the browser, the first analysis module will analyze the elements of the web page, and identify what elements are user interaction elements. In our example, there may be input fields for username and password, as well as buttons to authenticate and register.

Step 2: Based on the user interaction elements found, the second determination module will identify possible macroscopic actions on the page. In our example, the macroscopic actions found would be (1) “Authenticate”, and (2) “Create an account.”

Step 3: In order to decide whether to authenticate the user to create an account for him, the third module of traffic control, which guarantees the logic of the purchase, verifies that it has the information necessary to make this decision based on the history of actions previously taken, and information given by the consumer, indicating whether or not the consumer is an existing customer of the website in question. If any of this information is missing, the third module of the navigation control will solicit it from the consumer.

Step 4: Using all of the above information, the third module of navigation control will be able to identify the next macroscopic action to perform. Here, for example, if the consumer has an account and chose to use it then the third control module will select the authenticate navigation action to perform on behalf of the user, otherwise it will select the “create an account” macroscopic action.

Step 5: Once the macroscopic action is chosen, the third module of traffic control will check that all information necessary for the realization of the action is available in the database of personal consumer information. In this example, the username and password for the consumer should be available to perform the authentication action. Once again, if information is missing, then the third module of the navigation control will ask the consumer to supply that information prior to continuing with its execution.

Step 6: If the third control module of the navigation has all the information needed to continue, it will launch the implementation of the action macroscopic “authenticate the consumer” process, which can comprise three basic actions: (1) Provide the consumer login; (2) Insert the consumer's password; (3) Simulate a click on the link to authenticate.

Step 7: The third module navigation control waits to see if the implementation of the action leads to loading of a new web page. After a preset time, if no page is loaded, then steps 3 through 6 are performed again to perform another macroscopic action, if any others exist to perform. If on the other hand, a page is loaded by the macroscopic action, all steps are performed again.

In one embodiment, purchasing automation recognizes vendor's websites that allows for recording of a user's personal information, e.g., credit card/payment or address information for future purchases. In such cases, the purchasing automation methods and systems recognize that such user information has been recorded previously for the vendor on whose website the purchasing is taking place. The semantic analysis of the page uses form signatures (e.g., for address forms or credit card forms) and compares the form with the consumer personal information database to determine that the user has provided such information in the past for this vendor. This determination then aids the automation process.

In another embodiment, the methods and systems of purchasing automation may have to determine that navigation or automation has reached the last page of the purchasing sequence. In some cases, that determination is based on where the user provides payment information. In other cases, the payment page is not the last page and context of other elements on the page will be used to determine if another page will be visited in the shopping sequence to reach the final or confirmation page. Once the last page is determined, then a pop-up confirmation can be displayed for the user to confirm or cancel the transaction.

In one industrial application, the method of the invention can be implemented by programming an Internet browser plug-in, which the consumer has installed on a multimedia terminal that can connect to the Internet, such as a computer or mobile phone. In addition, the inventive system may use a physical object having electronic storage capabilities that can incorporating a data storage medium on which the database of personal consumer information and/or the database of purchase history are maintained, separate from the client device used, as might be done when the client device is a shared device shared among multiple consumers desiring to keep their information separate.

Aspects of the invention can be implemented in software running on the client computer, and possibly elsewhere. Aspects of the invention might also be implemented in hardware or implemented by program code on computer-readable media that, when executed by hardware, performs the programmed aspects. As one example, the program code might be provided over a network in downloadable form that can be executed by a user at a client computer to implement various aspects of the invention.

As explained above, the user might be a consumer making purchases by interacting with web pages of different websites. A downloaded program or programs can include a plug-in that takes actions as if it were the user taking actions, as well as storing and/or recording information that is presented to the user. In this manner, the system can assist with purchase processes, and can do so without requiring advance notice of the structure of the web pages that the vendors use and without requiring a formalized computer-to-computer interface.

The client device is a computer, computing device, smart phone, etc. that has the ability to run programs, display information to a user and accept user input. Typically, the display is a screen. Typically, the client device has some network connection, wired or wireless. The client device has computing capability, such as a processor that executes sets of instructions, and storage for the program code comprising the sets of instructions. In particular embodiments, there is storage for user data, such as a user database (which can be structured, unstructured, textual, binary, etc.) that contains user data (name, credit card numbers, addresses, purchase history, etc.) often in an encrypted form. The client device is able to read and write to such storage, referred to herein as the “user database” although it should be understood that specific database structures are not required. In some cases, there are multiple databases, such as a user details database and a purchase history database, but it should be apparent that different storage structures are possible.

In some cases, the data and/or program instructions are stored on physical medium separate from the client device and is provided with security means and means of communication with the multimedia device. For example, the security means might be a biometric reader that authenticates the consumer/user, for example, using fingerprint recognition. The interface might be a conventional USB or Bluetooth™ connection. This variant involving a physical medium allows consumers to make their purchases from any multimedia device while securing access to personal data and allowing access and preservation of purchase history, independent of the client device used. This would be useful where the user is using a shared computer.

The present invention is not limited to the preferred embodiment and implementation described, and may be modified or adapted to the needs or requirements, without departing from the scope of the invention.

What is claimed is:

1. A method for online purchase automation, for use with a computer or computing device usable by a user having an interface, the method comprising:
identifying when the user has selected to navigate to or receive a web page related to a purchasing action, wherein a purchasing action is an action taken by the user to further a purchase, browsing or shopping process between the user and a vendor or supplier that sells goods or services via a website that includes the selected web page;
identifying when content of the user-navigated web page is received;
analyzing the received user-navigated web page concurrent with the purchase action or shopping action, without requiring detailed structural information about the user-navigated web page in advance;
determining whether the user-navigated web page is related to a purchasing action, by parsing, using program instructions, the user-navigated web page or related data elements;
if the user-navigated web page is related to a purchasing action, determining, by analyzing using program instructions, the user interface elements of the user-navigated web page or related data elements;
retrieving site-independent customer data for the purchase based on the analyzing of the user interface elements of the user-navigated web page or related data elements; and
simulating user input using the site-independent customer data to populate at least portions of the user-navigated web page.

2. The method of claim 1, further comprising providing a means for the user to select a type of purchase automation upon detection of the user's desire to consummate a purchase.

3. The method of claim 1, wherein concurrent analyzing is analyzing such that a user sees timely automation responses.

4. The method of claim 3, further comprising automatically taking the user macro-action on the populated webpage where the user has selected an auto purchase option.

5. The method of claim 4, further comprising automatically pre-populating and executing pages of the shopping sequence until a confirmation page is reached.

6. The method of claim 4, wherein the automatically taking of the user macro-action is based on a user preference, wherein the user preference indicates that the action should be automated on behalf of the user.

7. The method of claim 1, further comprising:
executing user purchasing pages, the executing comprising:
repeating a set of steps until a purchase confirmation page is reached, the steps comprising:
(a) analyzing all components of the page and identifying the elements of user interaction;
(b) determining macroscopic actions that a user may take on the page based on the analyzing;
(c) retrieving site-independent customer data based on the analyzing;
(d) populating the page with the retrieved site-independent data; and
(e) performing the macroscopic user action until the performing of the macroscopic action leads to the loading of a new web page or significant changes to the page being analyzed of the website at which the user would consummate the purchase.

8. The method of claim 7, further comprising:
soliciting missing information from the user; and
populating the page with user-supplied information.

9. The method of claim 7, further comprising recording of screen shots of web pages executed on behalf of the user.

10. A purchasing automation system, the system comprising:
a display device; and
a processor configured to:
(a) identify when the user has selected to navigate to or receive a web page related to a purchasing action, wherein a purchasing action is an action taken by the user to further a purchase, browsing or shopping process between the user and a vendor or supplier that sells goods or services via a website that includes the selected web page;
(b) identify when content of the user-navigated web page is received;
(c) analyze the received user-navigated web page concurrent with the purchase action or shopping action, without requiring detailed structural information about the user-navigated web page in advance;
(d) determine whether the user-navigated web page is related to a purchasing action, by parsing, using program instructions, the user-navigated web page or related data elements;
(e) if the user-navigated web page is related to a purchasing action, determine, by analyzing using program instructions, the user interface elements of the user-navigated web page or related data elements;
(f) retrieve site-independent customer data for the purchase based on the analyzing of the user interface elements of the user-navigated web page or related data elements; and
(g) simulate user input using the site-independent customer data to populate at least portions of the user-navigated web page.

11. A purchasing automation system, the system comprising:
a display device; and
a processor configured to loop through a set of steps until a purchase confirmation page is reached, the set of steps comprising:
(a) analyze all components of the page and identifying the elements of user interaction;
(b) determine macroscopic actions that a user may take on the page based on the analysis;
(c) retrieve site-independent customer data based on the analyzing;
(d) populate the page with the retrieved site-independent data; and
(e) perform the macroscopic user action until the performing of the macroscopic action leads to the loading of a new web page or significant changes to the page being analyzed of the website at which the user would consummate the purchase.
